(19) United States
(12) Patent Application Publication
(10) Pub. No.: US 2016/0225047 A1
(43) Pub. Date: Aug. 4, 2016

(54) CONDITION COLLABORATION SYSTEM

(71) Applicants: Achim Lehmann, Kirkel (DE); Thomas Weiler, Schwalbach (DE)

(72) Inventors: Achim Lehmann, Kirkel (DE); Thomas Weiler, Schwalbach (DE)

(21) Appl. No.: 14/609,081

(22) Filed: Jan. 29, 2015

(51) Int. Cl. G06Q 30/06; G06Q 30/02; G06Q 10/06; G06Q 10/08

(52) U.S. Cl. CPC G06Q 30/0609; G06Q 30/0635; G06Q 10/08345; G06Q 30/0223; G06Q 10/0633

(57) ABSTRACT

The present disclosure involves systems, software, and computer implemented methods for enabling collaboration between transaction participants. One example method includes: receiving, at a collaboration system remote from a first participant and a second participant, a request for a transaction, the request sent by the first participant and associated with the second participant and including a set of request parameters; identifying, at the collaboration system, a set of conditions associated with the request, wherein each identified condition includes information that matches the second participant and at least one request parameter and pre-defined information to apply to the request; applying, at the collaboration system, each of the identified conditions in response to the received request; and generating, at the collaboration system, a responsive communication in response to applying the identified conditions, wherein the responsive communication provides a response to the request sent by the first participant on behalf of the second participant.

### TECHNICAL FIELD

The present disclosure relates to computer-implemented methods, software, and systems for enabling collaboration between transaction participants.

### BACKGROUND

Management of a supply chain for a product or service can include coordination of entities involved in the delivering of the product or service from an original supplier to an end customer. Activities related to sourcing, procurement, and logistics can be managed. Entities can include suppliers, intermediaries, and third-party service providers. Management of the supply chain can include linking business functions within and across companies. Business to business (B2B) transactions can occur between entities of the supply chain. For example, B2B transactions can occur between a manufacturer and a wholesaler, or between a wholesaler and a retailer.

### SUMMARY

The present disclosure involves systems, software, and computer implemented methods for enabling collaboration between transaction participants. One example method includes: receiving, at a central collaboration system remote from a first participant and a second participant, a request for a transaction, the request sent by the first participant and associated with the second participant and including a set of request parameters; identifying, at the central collaboration system, a set of conditions associated with the request, wherein each identified condition includes information that matches the second participant and at least one request parameter and pre-defined information to apply to the request; applying, at the central collaboration system, each of the identified conditions in response to the received request; and generating, at the central collaboration system, a responsive communication in response to applying the identified conditions, wherein the responsive communication provides a response to the request sent by the first participant on behalf of the second participant

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIGS. 1 and 2 are block diagrams illustrating example systems for enabling collaboration between transaction participants.

FIG. 3 is a flowchart of an example method for enabling collaboration between transaction participants.

FIG. 4 is a block diagram of an exemplary computer according to an implementation.

### DETAILED DESCRIPTION

Business-to-business (B2B) transactions can occur between collaborating participants, such as a vendor and a retailer. A cost for the shipment of goods can be based on a number of conditions, such as the order date, delivery date, and quantity ordered. Discounts may be applicable as well, depending on various conditions. The retailer, for example, may have an expectation of cost given the conditions related to the purchase. The vendor may determine a cost that is different from the expectations of the retailer. A final cost may need to be negotiated between the two participants, which can involve significant back and forth communication. As an alternative, a central collaboration system can be used to facilitate and to at least partially automate transactions between the collaborating participants. Each participant can provide condition information and master and structural data (e.g., article data, sales organization data) to the central collaboration system, which can then be used to automatically determine a price for a delivery, for example. The central collaboration system can include other features, as described below.

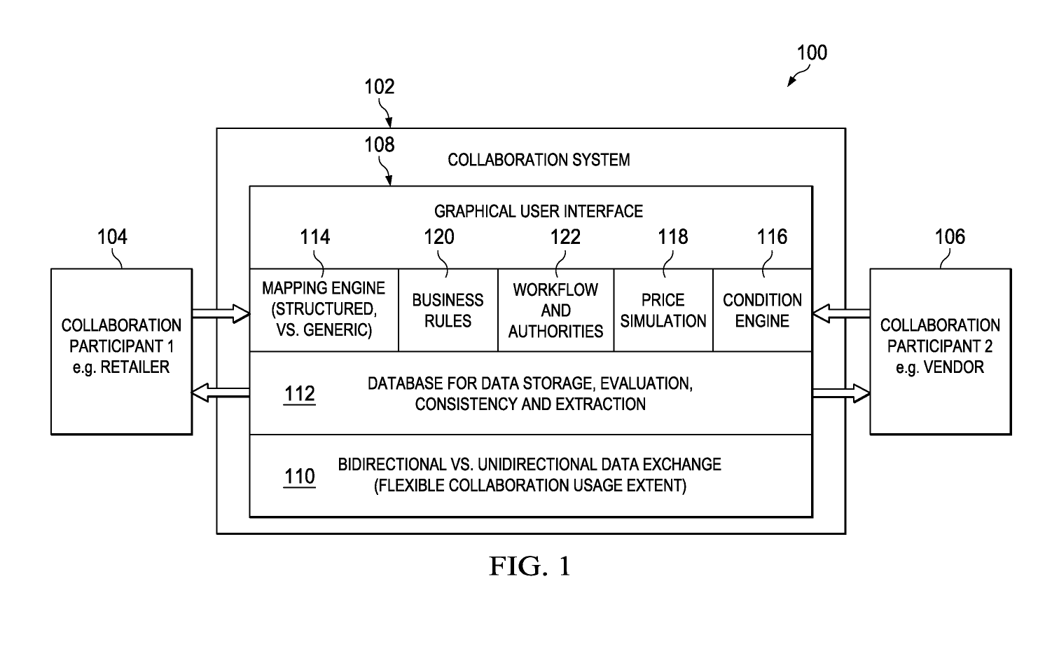

FIG. 1 is a block diagram illustrating an example system 100 for enabling collaboration between transaction participants. The system 100 includes a centralized collaboration system 102 which can be used by a first participant 104 and a second participant 106. The first participant 104 and the second participant 106 can be any parties that participant in a collaborative marketplace, for example. The first participant 104 can be, for example, a retailer. The second participant 106 can be, for example, a vendor. The first participant 104 may purchase items from the second participant 106 and/or may request information related to the second participant 106.

As described in more detail below, the first participant 104 and the second participant 106 can each provide information to the centralized collaboration system 102, such as master and structural data and logistical condition data. Master data is data that typically remains the same over a long period of time, such as generally static information about products, customers, and materials, to name a few examples. Structural data can include data about an organizational structure of the first participant 104 and/or the second participant 106. For example, structural data can describe a sales organization. Logistical condition data is data that describes how a condition may affect a request (e.g., transaction request). For example, a condition can affect pricing.

The centralized collaboration system 102 can, for example, provide a graphical user interface (GUI) 108 and/or a data exchange interface 110 for providing master data, structural data, and condition information. Data received from the first participant 104 or the second participant 106 can be stored in a database 112. A mapping engine 114 can map structural and/or master data provided by the first participant 104 to corresponding structural or master data provided by the second participant 106.

The centralized collaboration system 102 can be used to automate the providing of information to the first participant 104 in response to requests sent by the first participant 104 for information associated with the second participant 106. For example, the first participant 104 can send a pricing request for an item (e.g., article, product, service) offered by the second participant 106. In response to a request from the first participant 104, a condition engine 116 can identify a set of conditions associated with the request. For example, the condition engine 116 can identify one or more conditions which match one or more request parameters associated with the request and that match the second participant 106. Each identified condition can include pre-defined master data to apply when generating a response to the request. The condition engine 116 can apply each of the identified conditions to generate a responsive communication and can provide the responsive communication to the first participant 104. For example, pricing information can be provided in response to a pricing request.

In some implementations, processing related to the request in addition to sending the responsive communication is automatically initiated. For example, the request sent by the first participant 104 can be a purchase order. A confirmation of pricing information for the purchase order can be sent to the first participant 104. The centralized collaboration system 102 can interface with one or more other systems with regards to initiation of processes related to the purchase order. For example, the centralized collaboration system 102 can provide information to another system that results in creation of a sales order for the second participant 106 based on the purchase order. Procurement and shipping procedures can be automatically initiated by another system based on the sales order. Creation of an invoicing document can also be automatically initiated. Pricing information included in the invoicing document can match the pricing information sent earlier to the first participant 104, since both the pricing information in the invoicing document and the pricing information sent earlier to the first recipient 104 can be determined based on a same set of conditions maintained by the centralized collaboration system 102.

In some implementations, the request sent by the first participant 104 is a simulation request identified by a simulation engine 118. The simulation request can be a request for which the first participant 104 desires a response but which is not to be sent (at least not initially) to the second participant 106. The centralized collaboration system 102 can determine a responsive communication for the simulation request and send the responsive communication (e.g., pricing information) to the first participant 104. The first participant 104 can send, in time, multiple simulation requests, for example, to see the effects of changing one or more conditions (e.g., quantity, delivery date) associated with the request.

The centralized collaboration system 102 can enable negotiation between the first participant 104 and the second participant 106. The request sent by the first participant 104 can include a requested discount, for example. The second participant 106 can use the centralized collaboration system 106 to respond to the discount request (e.g., to accept the requested discount, reject the requested discount, or propose a different discount).

In some implementations, the centralized collaboration system 102 applies one or more business rules 120 in association with a request, a condition, or a negotiation. Business rules are specific rules and logic to be applied when performing a business process. Some business rules, for example, can trigger one or more work flows performed by a work flow engine 122. For example, a business rule can specify that if a requested discount received from the first participant 106 is more than a threshold, a request is to be sent to a predefined approver who can manually approve, reject, or negotiate the requested discount. As another example, a business rule can define a maximum discount which can be defined by a representative of the second participant 106 for a business partner associated with the second participant 106. Business rules can specify who can define, view, edit, or delete conditions, for example. A business rule can specify that an approval request is to be sent to an approver user associated with the second participant 106 if another user associated with the second participant 106 defines a condition to include a discount more than a threshold. A business rule can be associated with a KPI (Key Performance Indicator).

As illustrated, the data exchange interface 110 can be bidirectional or unidirectional. For example, the data exchange interface 110 can be used by the first participant 104 and the second participant 106 to provide information to the centralized collaboration system 102 and/or to exchange information between participants. The first participant 104 or the second participant 106 can query the centralized collaboration system 102 to retrieve master or structural data or condition data provided by the other participant, for example. Information can be retrieved from the centralized collaboration system 102 for use in an external system associated with the first participant 104 or the second participant 106 and separate from the centralized collaboration system 102.

Although two participants are illustrated in the system 100, the centralized collaboration system 102 can be used by many (e.g., thousands) of participants. For example, multiple retailers may use the centralized collaboration system 102, each in association with one or more vendors. The first participant 104 can, for example, send requests to the second participant 106 and also to other vendors.

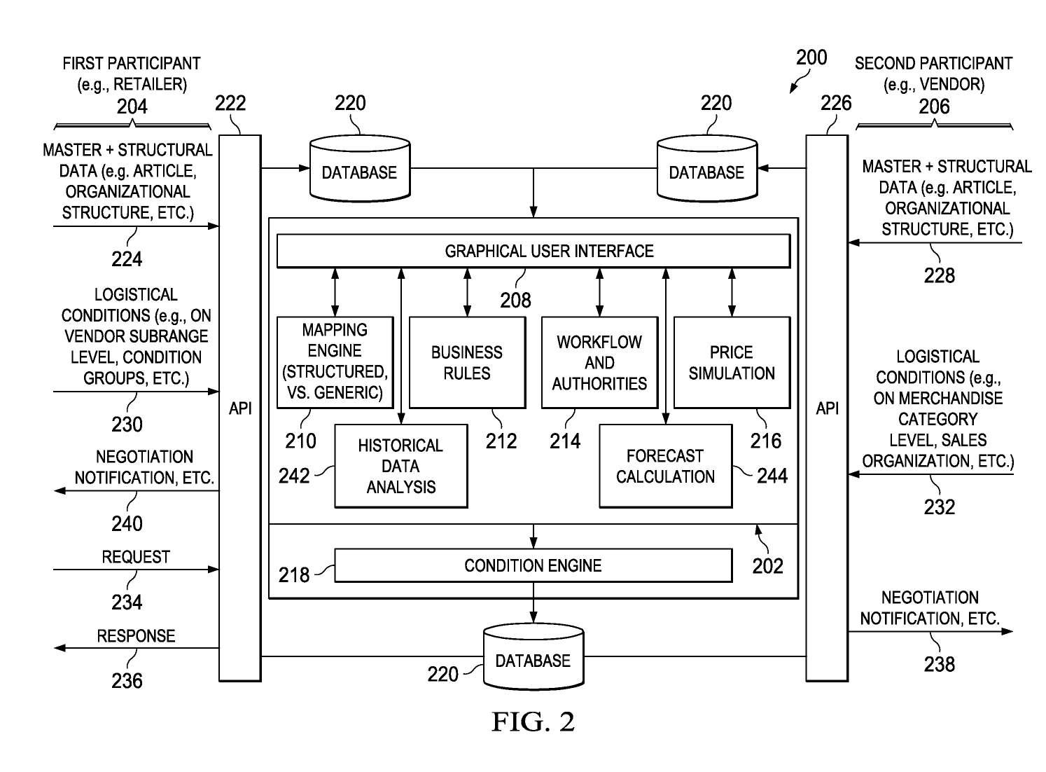

FIG. 2 is a block diagram illustrating an example system 200 for enabling collaboration between transaction participants. Similar to the system 100 described above with respect to FIG. 1, the system 200 includes a centralized collaboration system 202 which can be used by a first participant 206 (e.g., a retailer) and a second participant 206 (e.g., a vendor). A GUI 208, mapping engine 210, business rules 212, workflow engine 214, simulation engine 216, condition engine 218, and database 220 generally correspond to the GUI 108, the mapping engine 114, the business rules 120, the workflow engine 122, the simulation engine 118, the condition engine 116, and the database 112, respectively, of FIG. 1.

The first participant 204 can use the GUI 208 (or an Application Programming Interface (API) 222) to provide master and structural data 224 to the centralized collaboration system 202. Similarly, the second participant 206 can use the GUI 208 or an API 226 (the API 226 and the API 222 can be the same or different APIs) to provide master and structural data 228 to the centralized collaboration system 202. The master and structural data 224 and 228 can include, for example, information related to articles (e.g., products, materials), services, and organizational structures. Master data can be descriptive data that is infrequently changed. For example, master data for a product can include a product identifier, a product name, and a product description. Structural data can include data about an organizational structure of the first participant 204 and/or the second participant 206. For example, structural data can describe a sales organization associated with the second participant 206 which is responsible for selling products and/or services sold by the second participant 206. Sales organizations can be organizational units that structure the second participant 206 according to sales requirements.

The mapping engine 210 can map master and/or structural data provided by the first participant 204 to corresponding data provided by the second participant 206. For example, when the first participant 204 is a retailer and the second participant 206 is a vendor, organizational and article structures provided by each participant may differ from each other. For example, data provided by the first participant 204 may be associated with purchasing and data provided by the second participant 206 may be associated with sales. A purchasing price associated with a retailer can correspond to a sales price associated with a vendor. Purchasing data associated with the retailer may include the association of a purchasing price to a vendor sub range. Sales data associated with the vendor may include the association of a sales price with a sales organization. The mapping engine 210 can, for example, map vendor subrange information to sales organization information.

The first participant 204 and the second participant 206 can provide logistical conditions 230 and logistical conditions 232, respectively, to the centralized collaboration system 202 (e.g., using the API 222 and/or the GUI 208). A logistical condition includes information to apply to a request when the logistical condition matches a request (e.g., a transaction request). For example, a logistical condition can define the applying of a discount when the request is from a particular retailer. As another example, a logistical condition can define a price (and possibly a discount) given a request for a certain quantity of a product.

The logistical conditions 230 and/or the logistical conditions 232 can include, for example, information related to vendor sub ranges. Vendor sub ranges can be used to divide a set of products offered by the second participant 206. The first participant 204 and the second participant 206 can agree on pricing at a vendor sub range level, for example. The first participant 204 can provide information related to condition groups. The second participant 206 can provide information related to merchandise category levels and/or sales organizations. [0024] A condition can include or refer to data provided by the first participant 204, the second participant 206, or a third party. A condition can include embedded data, for example, that was previously provided by a participant. As another example, a condition can include a reference which indicates a data source from which to pull data (e.g., from a participant or a third party (e.g., shipping cost information may be pulled from a shipping provider).

The second participant 206 can define conditions (e.g., using the GUI 208) that are based on information that may be included in or otherwise associated with a request 234 sent by the first participant 204 for information (e.g., pricing) associated with the second participant 206. The request 234 can be, for example, a request for pricing for a certain quantity of a product offered by the second participant 206 to be delivered on a given delivery day. The condition engine 218 can identify a set of conditions that match the request 234 and the second participant 206. The set of identified conditions can be applied to the request 234 to generate a response 236 that is provided to the first participant 204. The response 236 can include, for example, pricing information for the request 234 that is determined based on the set of identified conditions.

A first condition can be identified and applied, for example, that determines a base price for the request 234 based on the requested product, quantity, and identity of the first participant 204. A second condition can be identified and applied that determines a shipping cost given the quantity and the requested delivery day. A third condition can be identified and applied that determines a discount (e.g., actual amount off, percentage off) given the quantity and the identity of the first participant 204. An overall cost can be determined by adding the base cost and the shipping cost and applying the discount. The overall cost can be included in the response 236 sent to the first participant 204.

As another example, the request 234 can include a requested discount. When the request 234 includes a requested discount, a business rule included in the business rules 212 can be identified which determines how to respond to the requested discount. For example, a business rule can specify to automatically accept a discount request below a threshold amount that is received from the first participant 204 (or from any participant). As described above, business rules can define whether one or more workflows are performed by the workflow engine 214.

A business rule can be configured to be made available to multiple participants of the centralized collaboration system 200. For example, a business rule may be applicable to many retailers, vendors, or other types of participants. As another example, the centralized collaboration system 200 can be configured to enable definition and performance of business rules which are specific to a particular recipient. For example, the first participant 204 can use the centralized collaboration system 200 to define a business rule that is specific to the first participant 204. In some implementations, the first participant 204 can define a business rule by modifying or enhancing a predefined business rule. [0029] A requested discount is one example of how the centralized collaboration system 202 can be configured to enable negotiation between the first participant 204 and the second participant 206. A workflow that is identified in response to the request 234 can be performed which results in a negotiation notification 238 being sent to the second participant 206 (e.g., if a requested discount is greater than a threshold). The workflow can be configured to send the negotiation notification 238 to a predefined approver user associated with the second participant 206, for example. The approver user can use the GUI 208 to receive and respond to the negotiation notification 238, for example. The response from the approver user can be to accept or reject the requested discount or to provide a counter-offer regarding the requested discount to the first participant 204. The first participant 204 can receive the counter-offer as a negotiation notification 240, for example. Other types of negotiation scenarios are possible.

The centralized collaboration system 202 can include other components, such as a historical data analysis engine 242 and a forecast calculation engine 244. The historical data analysis engine 242 can be used by the first participant 204 and/or the second participant 206, for example, for negotiation purposes. For example, the first participant 204 or the second participant 206 can query the historical data analysis engine 242 to determine historical information including past discounts, base costs, shipping costs, etc. for orders associated with the first participant 204 and the second participant 206, and can use the historical information when negotiating a price or discount for a current order. The simulation engine 216 can use historical information when performing simulations.

In some implementations, the response 236 (or the negotiation notification 240) can include a suggestion for a change to the request 234. For example, a modified quantity can be suggested. The modified quantity can be determined by the second participant 206 or by the condition engine 218, for example. The condition engine 218 can determine, for example, that an improved shipping efficiency can be obtained if the requested quantity is either increased or decreased (for example, given the requested quantity, a last truck used for shipping the requested product(s) may be mostly, but not completely full, and increasing the quantity to fill the last truck may be more efficient (e.g., more quantity shipped without increasing a shipping cost) than using the requested quantity). As another example, the last truck used for shipping the requested quantity of products may be only slightly full, and decreasing the requested quantity slightly may decrease the shipping cost while only slightly decreasing the quantity.

The forecast calculation engine 244 can generate one or more forecasts such as related to one or more KPIs (e.g., budget, margin, sales ratio, revenue). A forecast generated by the forecast calculation engine 244 can include, for example, forecasted discounts over a certain period of time given forecasted quantities and current negotiated discounts between the first participant 204 and the second participant 206.

The centralized collaboration system 202 can include, for example, one or more applications (e.g., desktop, cloud-based, web-based applications) provided by one or more servers. The database 220 can be implemented as a single database or as multiple databases (e.g., as illustrated in FIG. 2). The database 220 can be or can include an in-memory database or one or more other types of databases. As described above for the system 100, although two participants are illustrated in the system 200, the centralized collaboration system 202 can be used by many (e.g., thousands) of participants. The centralized collaboration system 202 can be remote from the first participant 204 and the second participant 206. As another example, some or all of the centralized collaboration system 202 can be on the premises of one or more of the participants.

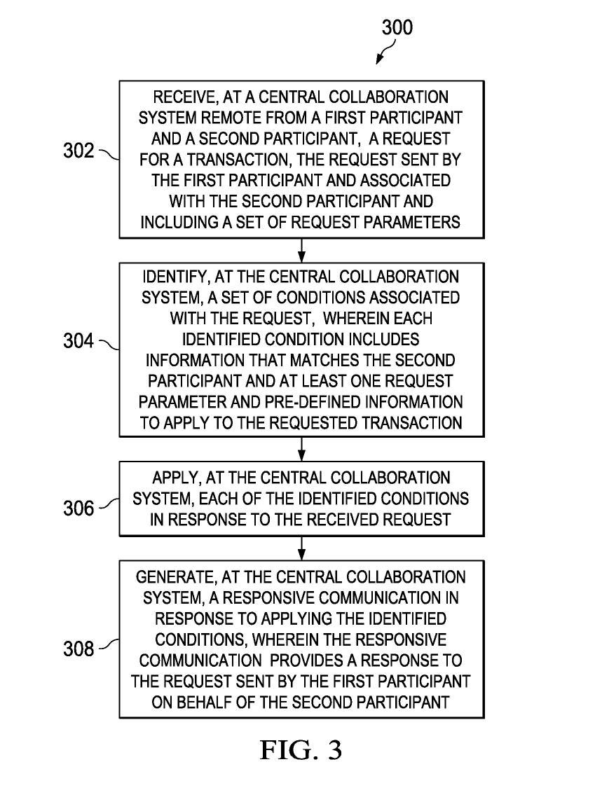

FIG. 3 is a flowchart of an example method 300 for enabling collaboration between transaction participants. It will be understood that method 300 and related methods may be performed, for example, by any suitable system, environment, software, and hardware, or a combination of systems, environments, software, and hardware, as appropriate. For example, one or more of a client, a server, or other computing device can be used to execute method 300 and related methods and obtain any data from the memory of a client, the server, or the other computing device. In some implementations, the method 300 and related methods are executed by one or more components of the system 100 described above with respect to FIG. 1. For example, the method 300 and related methods can be executed by the centralized collaboration system 102 of FIG. 1.

At 302, a request for a transaction is received at a central collaboration system remote from a first participant and a second participant, The request is sent by the first participant and associated with the second participant. The request includes a set of request parameters. The first participant can be a retailer and the second participant can be a vendor, for example. The request parameters can include information related to one or more products or services offered by the vendor. For example, the request parameters can include a product identifier, a request date, a requested delivery date, and a requested quantity for each product. The central collaboration system can map the product identifier provided by the first participant to a product identifier associated with the second participant, such as using master and/or structural data previously provided by the first and second participants.

At 304, a set of conditions associated with the request is identified at the central collaboration system, Each identified condition includes information that matches the second participant and at least one request parameter, and pre-defined information to apply to the request. The identified conditions can include one or more pricing conditions that each include a pricing value that is based on a requested quantity. A pricing value can be based on a shipping cost of shipping the requested quantity, for example. As another example, a pricing value can be associated with a discount that is based on the requested quantity and one or more of the first participant and the second participant. Other types of pricing, rebates, discounts, offers, or bonuses can be associated with a condition. A condition can be associated with a condition type. As described above, one or more business rules associated with the request can also be identified.

At 306, each of the identified conditions are applied to the request at the central collaboration system in response to the received request. For example, one or more pricing conditions can be applied to the request, including the applying of the pricing value of each pricing condition, to determine pricing information. If one or more business rules have been identified, the identified business rule(s) can be applied.

At 308 a responsive communication is generated, at the central collaboration system, in response to applying the identified conditions. The responsive communication provides a response to the request sent by the first participant on behalf of the second participant. The responsive communication can, for example, include pricing information for the requested transaction. As another example, the responsive communication can include a suggested change to one or more request parameters. For instance, when the request parameters include a requested quantity, the suggested change can be a suggested quantity that is a change to the requested quantity. The suggested quantity can be suggested to improve a shipping efficiency of shipping the suggested quantity as compared to shipping the requested quantity, for example.

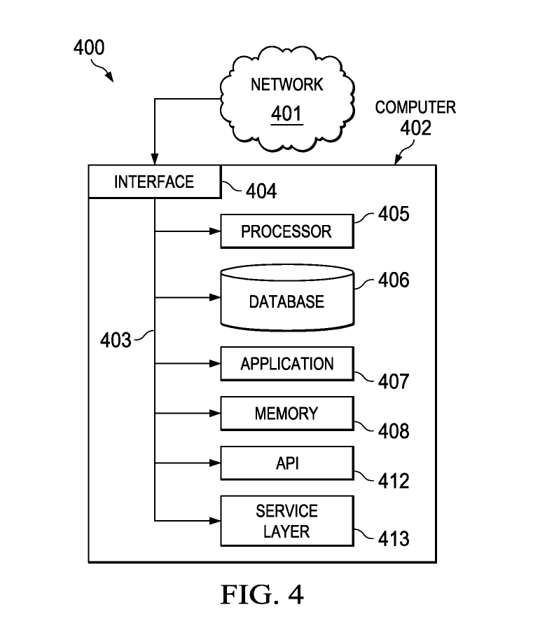

FIG. 4 is a block diagram 400 of an exemplary computer 402 used in the system 200 according to an implementation. The illustrated computer 402 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 402 may comprise a computer that includes an input device, such as a keypad, keyboard, touch screen, or other device that can accept user information, and an output device that conveys information associated with the operation of the computer 402, including digital data, visual and/or audio information, or a GUI.

The computer 402 can process for/serve as a client (e.g., client devices associated with the first participant 204 or the second participant 206, and/or any other component of the system 200 (whether or not illustrated). The illustrated computer 402 is communicably coupled with a network 401. In some implementations, one or more components of the computer 402 may be configured to operate within a cloud-computing-based environment.

At a high level, the computer 402 is an electronic computing device operable to receive, transmit, process, store, or manage data and information associated with the system 200. According to some implementations, the computer 402 may also include or be communicably coupled with a cloud-computing server, application server, e-mail server, web server, caching server, streaming data server, business intelligence (BI) server, and/or other server.

The computer 402 can receive requests over network 401 from a client application (e.g., a mobile UI and/or web-based application UI executing on another computer 402) and responding to the received requests by processing the said requests in an appropriate software application. In addition, requests may also be sent to the computer 402 from internal users (e.g., from a command console or by other appropriate access method), external or third-parties, other automated applications, as well as any other appropriate entities, individuals, systems, or computers.

Each of the components of the computer 402 can communicate using a system bus 403. In some implementations, any and/or all the components of the computer 402, both hardware and/or software, may interface with each other and/or the interface 404 over the system bus 403 using an API 412 and/or a service layer 413. The API 412 may include specifications for routines, data structures, and object classes. The API 412 may be either computer-language independent or dependent and refer to a complete interface, a single function, or even a set of APIs. The service layer 413 provides software services to the computer 402 and/or the system 200. The functionality of the computer 402 may be accessible for all service consumers using this service layer. Software services, such as those provided by the service layer 413, provide reusable, defined business functionalities through a defined interface. For example, the interface may be software written in JAVA, C++, or other suitable language providing data in extensible markup language (XML) format or other suitable format. While illustrated as an integrated component of the computer 402, alternative implementations may illustrate the API 412 and/or the service layer 413 as stand-alone components in relation to other components of the computer 402 and/or system 200. Moreover, any or all parts of the API 412 and/or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402 and/or system 200. The interface 404 is used by the computer 402 for communicating with other systems in a distributed environment—including within the system 200—connected to the network 401 (whether illustrated or not). Generally, the interface 404 comprises logic encoded in software and/or hardware in a suitable combination and operable to communicate with the network 401. More specifically, the interface 404 may comprise software supporting one or more communication protocols associated with communications such that the network 401 or interface's hardware is operable to communicate physical signals within and outside of the illustrated system 200.

The computer 402 includes a processor 405. Although illustrated as a single processor 405 in FIG. 4, two or more processors may be used according to particular needs, desires, or particular implementations of the computer 402 and/or the system 200. Generally, the processor 405 executes instructions and manipulates data to perform the operations of the computer 402. Specifically, the processor 405 executes the functionality required for enabling collaboration between transaction participants.

The computer 402 also includes a database 406 and memory 408 that hold data for the computer 402 and/or other components of the system 200. Although illustrated as a single database 406 and memory 408 in FIG. 4, two or more databases 408 and memories 408 may be used according to particular needs, desires, or particular implementations of the computer 402 and/or the system 200. While database 408 and memory 408 are illustrated as integral components of the computer 402, in alternative implementations, the database 406 and memory 408 can be external to the computer 402 and/or the system 200. In some implementations, the database can be a conventional database or an in-memory database, or a mix of both. In some implementations, the database 406 and memory 408 can be combined into one component.

The application 407 is an algorithmic software engine providing functionality according to particular needs, desires, or particular implementations of the computer 402 and/or the system 200, particularly with respect to functionalities required for providing the described enabling of collaboration between transaction participants. For example, application 407 can serve as the condition engine 218, the workflow engine 214, and/or any other component of the system 200 (whether or not illustrated). Further, although illustrated as a single application 407, the application 407 may be implemented as multiple applications 407 on the computer 402. In addition, although illustrated as integral to the computer 402, in alternative implementations, the application 407 can be external to the computer 402 and/or the system 200.

There may be any number of computers 402 associated with, or external to, the system 200 and communicating over network 401. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

The preceding figures and accompanying description illustrate example processes and computer-implementable techniques. But system 200 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 200 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method comprising:
receiving, at a central collaboration system remote from a first participant and a second participant, a request for a transaction, the request sent by the first participant and associated with the second participant and including a set of request parameters;
identifying, at the central collaboration system, a set of conditions associated with the request, wherein each identified condition includes information that matches the second participant and at least one request parameter and pre-defined information to apply to the request;
applying, at the central collaboration system, each of the identified conditions in response to the received request; and
generating, at the central collaboration system, a responsive communication in response to applying the identified conditions, wherein the responsive communication provides a response to the request sent by the first participant on behalf of the second participant.

2. The method of claim 1, wherein the first participant is a retailer, the second participant is a vendor, and the request parameters include information related to one or more products or services offered by the vendor.

3. The method of claim 2, wherein the request parameters include a product identifier, a request date, a requested delivery date, and a requested quantity for each product, the method further comprising mapping the provided product identifier to a second product identifier associated with the second participant and determining pricing information to be included in the responsive communication.

4. The method of claim 3, wherein the request parameters comprise a purchase order, the method further comprising providing information for creation of a sales order associated with the second participant based on the purchase order.

5. The method of claim 3, wherein the identified conditions include a pricing condition that includes a pricing value that is based on the requested quantity and applying the pricing condition includes applying the pricing value to determine the pricing information.

6. The method of claim 5, wherein the pricing value is based on a shipping cost of shipping the requested quantity.

7. The method of claim 5, wherein the pricing value comprises a discount that is based on the requested quantity.

8. The method of claim 1, wherein the responsive communication includes a suggested change to one or more request parameters.

9. The method of claim 8, wherein the suggested change is a suggested quantity that is a change to the requested quantity, the suggested quantity being suggested to improve a shipping efficiency of shipping the suggested quantity as compared to shipping the requested quantity.

10. The method of claim 1, wherein the central collaboration system comprises a simulation system and the request for the transaction includes a set of first request parameters, the method further comprising:
receiving a second request from the first participant, the second request including a set of second request parameters that include a change to the set of first request parameters; identifying, at the central collaboration system, a second set of conditions associated with the second request;
applying, at the central collaboration system, the second set of conditions; and
generating, at the central collaboration system, a second responsive communication in response to applying the second set of conditions, wherein the second responsive communication provides a response to the second request.

11. The method of claim 1, wherein the central collaboration system is configured to enable negotiation between the first participant and the second participant.

12. The method of claim 1, further comprising receiving, at the central collaboration system and from the first participant and the second participant, master data including product information, and structural data including sales organization information.

13. The method of claim 1, further comprising identifying a sales organization associated with the requested transaction and the second participant.

14. The method of claim 1, further comprising identifying, at the central collaboration system, one or more business rules associated with the request; and applying, at the central collaboration system, each of the identified business rules.

15. The method of claim 14, wherein the business rules comprise definition of restrictions or constraints related to the creation or modification of a condition.

16. The method of claim 14, wherein the business rules comprise definition of a workflow process to be performed in response to a runtime condition.

17. A computer program product encoded on a non-transitory storage medium, the product comprising non-transitory, computer readable instructions for causing one or more processors to perform operations comprising:
receiving, at a central collaboration system remote from a first participant and a second participant, a request for a transaction, the request sent by the first participant and associated with the second participant and including a set of request parameters;
identifying, at the central collaboration system, a set of conditions associated with the request, wherein each identified condition includes information that matches the second participant and at least one request parameter and pre-defined information to apply to the request;
applying, at the central collaboration system, each of the identified conditions in response to the received request; and
generating, at the collaboration system, a responsive communication in response to applying the identified conditions, wherein the responsive communication provides a response to the request sent by the first participant on behalf of the second participant.

18. The product of claim 17, wherein the first participant is a retailer, the second participant is a vendor, and the request parameters include information related to one or more products or services offered by the vendor.

19. A system comprising:
one or more computers associated with a database system; and
a computer-readable medium coupled to the one or more computers having instructions stored thereon which, when executed by the one or more computers, cause the one or more computers to perform operations comprising:
receiving, at a central collaboration system remote from a first participant and a second participant, a request for a transaction, the request sent by the first participant and associated with the second participant and including a set of request parameters;
identifying, at the central collaboration system, a set of conditions associated with the request, wherein each identified condition includes information that matches the second participant and at least one request parameter and pre-defined information to apply to the request;
applying, at the central collaboration system, each of the identified conditions in response to the received request; and
generating, at the collaboration system, a responsive communication in response to applying the identified conditions, wherein the responsive communication provides a response to the request sent by the first participant on behalf of the second participant.

20. The system of claim 19, wherein the first participant is a retailer, the second participant is a vendor, and the request parameters include information related to one or more products or services offered by the vendor.
